(19) United States
(12) Patent Application Publication
(10) Pub. No.: US 2008/0065273 A1
(43) Pub. Date: Mar. 13, 2008

(54) Method and device for adaptive control

(76) Inventors: Dan Gerrity, New York, NY (US); Subramanian Akkulan, Parsippany, NJ (US)

Correspondence Address: Davidson, Davidson & Kappel, LLC, 485 17th Avenue, 14th Floor, New York, NY, 10018, US

(21) Appl. No.: 11/895,979

(22) Filed: Aug. 28, 2007

Related U.S. Application Data
(60) Provisional application No. 60/840,623, filed on Aug. 28, 2006.

(51) Int. Cl. G06F 19/00; G05B 13/02; G05B 15/02; G06F 15/18

(52) U.S. Cl. 701/1; 700/1; 700/30; 706/21

(57) ABSTRACT

A method for controlling a system having embedded message elements includes dynamically altering a predetermined meaning of an embedded message element as a function of a system state.

This claims the benefit of U.S. Provisional Patent Application No. 60/840,623, filed on Aug. 28, 2006 and hereby incorporated by reference herein.

### BACKGROUND

K. S. Narendra and K. Parthasarathy disclose control of dynamical systems and optimization of dynamical system in, “Identification and control of dynamical systems using neural networks,” IEEE Trans. on neural networks, vol. 1, No. 1, March 1990; and K. S. Narendra and K. Parthasarathy, “Gradient methods for the optimization of dynamical systems containing neural networks,” IEEE Trans. on neural networks, vol. 2, No. 2, March 1991, both of which are incorporated by reference herein.

U.S. Pat. Nos. 6,967,594 and 6,650,251 disclose sensory monitors, and are hereby incorporated by reference herein.

### SUMMARY OF THE INVENTION

An object of the present invention is to provide a control system based upon Model Reference Indirect Adaptive Neural Control, MRIANC for measuring human perception at the edges of awareness. The control system can include a message transmitter (VDU) providing embedded messages u(k) (and/or embedded pre-semantic messages having a predetermined meaning or a predetermined object representation for visual priming,) embedded in supraliminal information, a sensory monitor for measuring reaction (in terms of control error, ê_{c}) in an individual to the embedded messages (and/or to the predetermined meaning or predetermined object representation of the embedded pre-semantic messages), and a controller (NN Controller) connected to the message transmitter (VDU), receiving an input from the sensory monitor, including a real-time feedback control loop altering a perceptibility of the embedded messages with respect to the supraliminal messages as a function of the sensory monitor input.

### BRIEF DESCRIPTION OF THE DRAWINGS

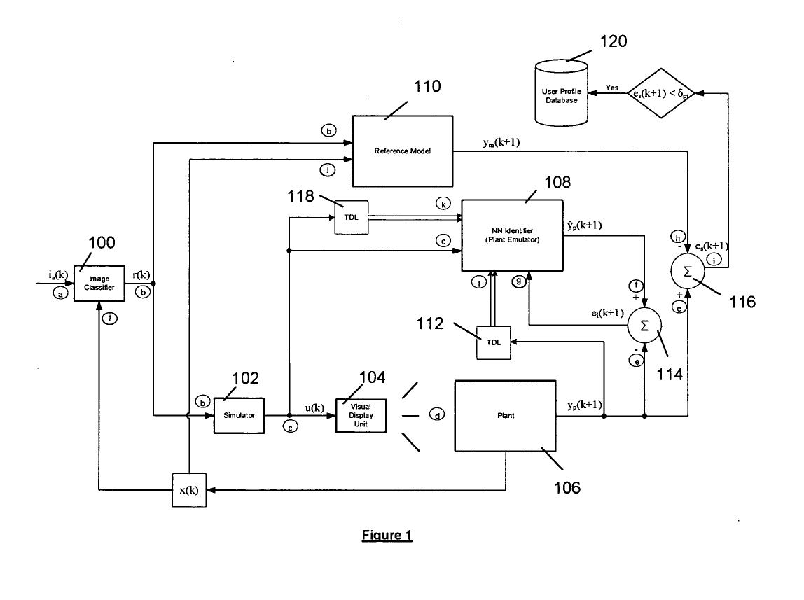

An identifier network is used to approximate the input/output relations of the plant as shown in an embodiment described in FIG. 1.

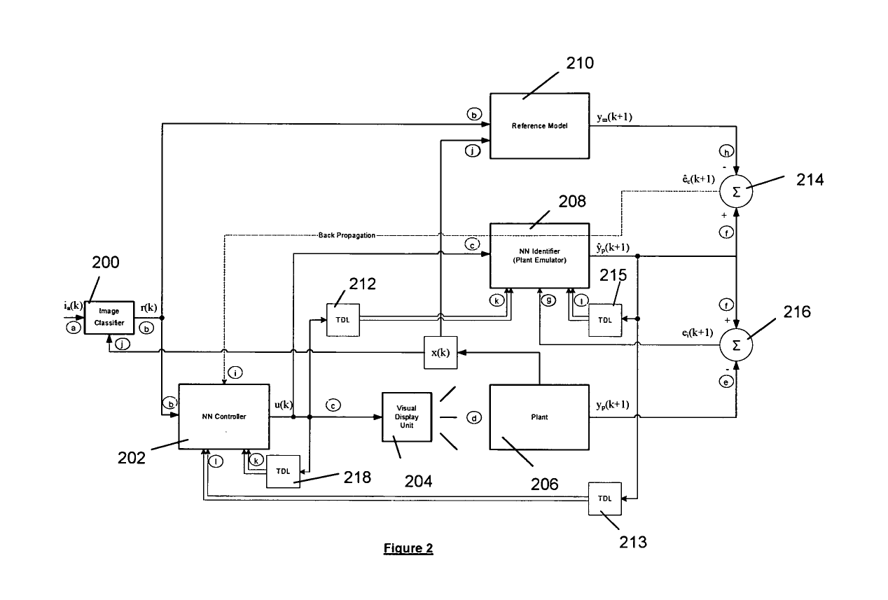

The architecture of a preferred embodiment of a control system is shown in FIG. 2 and referred to as a Model Reference Indirect Adaptive Neural Control (MRIANC).

### DETAILED DESCRIPTION

From systems theory, an unknown non-linear discrete-time dynamic system with given input-output pairs can be modeled mathematically by one of the four well-known difference equations, with Model IV (as described in the BACKGROUND papers above), also known as NARMA (Nonlinear Auto Regressive Moving Average) model, being the most general.

In the context of visual priming as described in U.S. Pat. Nos. 6,967,594 and 6,650,251, the human brain (and optionally together with a vehicle control system) can be modeled as an unknown non-linear dynamic plant.

Because of complexity of human brain, the most general plant model, the Model IV, can be used, as follows:

Model IV
yₚ(k+1)=f[yₚ(k), . . . , yₚ(k−n+1); u(k), . . . , u(k−m+1)]
m≦n (2.1)

This model can be used for example to provide visual priming signals to alter the response of the plant, i.e. the human brain and optionally a vehicle.

Adaptive control of a dynamic system can be defined as follows:

Given a plant model, a reference model and an input r(k), the input to the plant u(k), which will be the output of the controller, can be determined so that the response of the plant follows the reference model.

The problem can be divided into two parts: identification and control.

The identification step derives the identifier model such that the model follows the plant dynamics. The identifier model can be described by a neural network identifier as follows:

NN Identifier (Plant Emulator)
ŷₚ(k+1)=N_{f}[yₚ(k), . . . , yₚ(k−n+1); u(k), . . . , u(k−m+1)]
m≦n (2.2)

This representation, known as Serial-Parallel model, is used as off-line identifier model. When visually priming a driver, for example, the plant thus is first modeled off-line to obtain an estimate of how the driver and vehicle may react to certain inputs, and to minimize the identifier output error:

Identifier Output Error
eᵢ(k+1)=ŷₚ(k+1)−yₚ(k+1) (2.3)

Once the plant is identified with sufficient accuracy, the plant needs to be controlled by a neural network controller. In the visual priming example, this means that the controller will provide visual priming to the driver, which then should react according to the model.

Control is to utilize an appropriate controller model to track the arbitrary reference output (or trajectory) generated from the reference model. A neural network controller can be constructed to approximate the control law as given below.

Controller (NN)
u(k)=N_{c}[ŷₚ(k), . . . , ŷₚ(k−n+1); u(k−1), . . . , u(k−m+1); r(k); Σ]
m≦n (2.4)
where Θ represents the set of controller parameters, with a control output error being:

Control Output Error
ê_{c}(k+1)=ŷₚ(k+1)−yₘ(k+1) (2.5)

During on-line control, the plant then can continuously be further identified on-line. The on-line identifier model can use Parallel model as given below:
ŷₚ(k+1)=N_{f}[ŷₚ(k), . . . , ŷₚ(k−n+1); u(k), . . . , u(k−m+1)]
m≦n (2.6)

This representation is needed to adjust the parameters of the controller.

As described above, for the context of visual priming, the human brain together with the vehicle control system can be modeled as an unknown nonlinear dynamic plant.

This unknown nonlinear dynamic plant can be identified and controlled using a Model Reference Indirect Adaptive Neural Control (MRIANC) system.

The Model Reference in the MRIANC system makes sure that the plant has a reference model so that the response of a plant follows the reference model.

Indirect Adaptive Neural Control in MRIANC is meant for estimating the parameters of the plant using an identifier network (NN Identifier or Plant Emulator) and adjusting the control parameters based on these estimates in the controller network (NN Controller).

FIG. 1 describes in more detail a preferred embodiment of a system used for identification off-line. The numbers 1 to 12 follow steps described below.

Image Classifier

Image classifier 100 classifies the scanned image iₐ(k) that requires an operator's attention, for example a deer. Based upon the situation (plant state x(k) and object trajectory), classifier 100 extracts the reference object image r(k) (containing image itself and situation vector) from the scanned object.

Simulator

Simulator 102 generates an embedded message u(k) from the reference input along with simulated display features.

Visual Display Unit (VDU)

A message transmitter or VDU 104 displays an embedded message u(k) generated from Simulator, and this can be shown to the plant 106.

Plant

The human brain together with the vehicle control system is represented as a plant 106. Plant 106 is presented with an embedded message u(k) for visual priming. The operator's reaction in terms of vehicle control system is measured as plant's output. The operator's response time to recognize the actual object is reduced (due to less neurons fired for the object primed earlier) and operator's ability to discriminate or recognize object is improved (due to identification resulting not only from perception but also from the implicit memory formed by visual priming) that leads to less reaction time maneuvering the vehicle.

NN (Neural Network) Identifier/Plant Emulator

The emulator 106 models human sensory sensitivities (brain) and reaction (by way of vehicle control system state). Emulator 106 contains a neural network with adjustable parameters/weights. The identification error (eᵢ) between the plant output and emulator 106 updates the weight of the neural network so that the emulator 106 is sufficiently accurate before initiating the control action.

Reference Model (to Find the Optimal Priming)

A reference model 110 is used to establish a desired plant response in a given situation. For each simulated plant input u(k), the simulator error (eₛ) between plant output and the reference output is calculated. This error is compared with that in the database for a situation vector and if the new error is less than the stored error, the new controlled display features (c_{df}) along with the new error is stored into database with the situation vector as the key.

User Profile DB

The user profile 120 thus stores the operator's preconscious sensitivity in terms of display features for the optimal priming, corresponding situation vector and the simulator error.

TDL

Tapped delay lines represent the past values of the input and output of the plant.

Off-Line Process Flow as Described in FIG. 1

The following describes the generating of the user profile database, which occurs off-line, using the numbers shown with the arrows in FIG. 1, which do not necessarily occur in numerical order:

In step 1, the image classifier classifies an acquired/scanned object image into a redacted or reference object image that requires an operator's attention based upon the plant state and object trajectory.

In step 2, the reference object image r(k) and plant state are fed into the reference model 110 to establish a desired reference response. The reference object image r(k) also is fed into simulator 102 to generate simulated display features.

In step 3, simulator 102 produces simulated display features u(k) to be used for presenting an embedded message in VDU 104 for visual priming and to serve as input (along with situation vector) to be passed into plant emulator 108.

In step 4, the object image displayed with the simulated display features constituting an embedded message is presented to the plant 106.

The operator's reaction in step 5 as a plant output in terms of reaction time (tₚ) and action taken is measured as actual vehicle trajectory (such as acceleration aₚ(k+1) and driving angle αₚ(k+1)).

NN Identifier 108 in step 6 generates an output that estimates the operator's reaction by way of vehicle trajectory.

In step 7, the plant output is compared at comparator 114 with the NN Identifier output and the resulting error eᵢ(k+1) updates the weights of the NN Identifier 108.

In step 8, the reference output is used for determining simulator error by comparing at comparator 116 the reference output with plant output.

If the simulator error es between plant and reference model is less than the user profile threshold value and the stored simulator error, the user profile database in step 9 is updated with the new optimal embedded message parameters u(k) and the corresponding simulator error using the situation vector as the primary key.

In step 10, which can occur before step 1, the plant (or system) state is fed into the reference model 110 and image classifier 100.

In step 11, which can occur before or with step 3, past inputs of the plant 106 are fed as inputs into NN Identifier 108 for aiding in learning the plant 106.

In step 12, which can also occur before or with step 3, past outputs of the plant 106 are fed as inputs into NN Identifier 108 for aiding in learning the plant 106.

The iteration cycle is repeated until the process has been identified completely or at least sufficiently accurately. The user profile database can then be used on-line.

Control (On-line identification and control) of the plant 206, i.e. to influence a driver to respond to messages, is described with respect to FIG. 2

The controller network is used to approximate the control law that forces the plant output to follow the reference model output accurately. Identification and control may proceed simultaneously in a stable fashion provided that the initial identification of the plant is sufficiently accurate. The architecture of control system shown in FIG. 2 is Model Reference Indirect Adaptive Neural Control (MRIANC).

Image Classifier

Image classifier 200 can be the same as classifier 100 described in FIG. 1.

NN Controller

The control system includes a controller 202 having a real-time feed back control loop altering a perceptibility c_{df}(k) of an embedded message u(k) in such a way that the control error ê_{c}(k+1) measured between predetermined response yₘ(k+1) (desired operator response) and estimated operator response ŷₚ(k+1) (estimated vehicle trajectory by NN identifier) updates the weight parameter, i.e., altering c_{df}(k) in u(k) as a result of dynamic back propagation of ê_{c}(k+1)=ŷₚ(k+1)−yₘ(k+1).

Visual Display Unit (VDU)

A message transmitter 204, which may be the same as 104 in FIG. 1, displays an embedded message u(k) generated from NN Controller 202.

Plant

Plant 206 may be the same as described in with respect to plant 106.

NN Identifier/Plant Emulator

The NN identifier 208 may be the same as described in offline identification until the control action is initiated. During online control, identifier 208 estimates the vehicle trajectory of the plant. This estimated operator response ŷₚ(k+1) is compared with the reference model 210 output yₘ(k+1) resulting in the control error ê_{c}(k+1) used as a monitor for measuring the reaction of an operator to an embedded message u(k).

Reference Model

Reference model 210 provides desired plant response as a function of reference input r(k) and system state x(k). Control error ê_{c}(k+1) between the emulator 208 and the reference model 210 adjust the parameters/weights of the NN controller so that plant input u(k) from the controller 202 forces the plant output to follow the reference model output accurately.

TDL

Tapped delay lines 212, 213, 215, 218 represent the past values of the input and output of the plant emulator 208.

On-Line Process Flow as Described in FIG. 2

The steps for on-line control are as follows, although not necessarily occurring in numerical order:

In step a, the image classifier 200 classifies acquired/scanned object image, for example that identified by vehicle radar, into a redacted (bandpass filtered) or reference object image that requires an operator's attention based upon the plant state and object trajectory.

In step b. the reference object image classification along with plant state is fed into reference model 210 to establish a desired reference response. The reference object image also is fed into NN controller 202 to generate an embedded message.

In step c, the NN controller 202 produces an embedded message in VDU 204 for visual priming and to serve as an input to be passed into plant emulator 208.

In step d, an embedded message is presented to the plant 206 (Visual priming).

In step e, the operator's reaction as plant output in terms of reaction time (tp) and action taken is measured as actual vehicle trajectory (such as acceleration ap(k+1) and driving angle αₚ(k+1)).

The NN Identifier 208 in step f generates an output that estimates plant output such as estimated reaction time and estimated vehicle trajectory.

In step g, the identification error is determined: the plant output is compared in comparator 216 with the NN Identifier output and the resulting error ei(k+1) updates the weights of the NN identifier 208.

In step h, the reference output in terms of reference reaction time and reference vehicle trajectory is taken from reference model 210.

In step i, the control error êc(k+1) is measured between NN identifier 208 and reference model 210 so that the error can be backpropagated through NN identifier 208 to reach the NN controller 202. As the plant 206 is assumed to be identified sufficiently accurate by NN identifier 208, the control error êc(k+1) is used as a monitor for measuring the reaction of an operator to an embedded message u(k).

In step j, which may occur before step a, the plant (or system) state is fed into Reference Model and Image classifier.

In step k, past inputs of the plant 206 are fed as inputs into NN Identifier 208 for learning the plant as closely as possible and into NN Controller to generate an embedded message.

In step l, past outputs of the plant emulator 208 are fed as inputs into NN Identifier 208 and NN Controller 202 to adjust the controller parameters.

The NN Identifier 208 estimates the plant parameters via steps e and g NN controller 202 adjusts the controller parameters based on these estimates viasteps f and i to present an embedded message in step c for visual priming In step d. Overall, the control loop follows steps c, d, e, g, f, i.

Variables and Notations

iₐ(k), input to image classifier; scanned object image
r(k)=(i_{b}(k),sᵥ)=I(iₐ(k)),
reference input; redacted object image,
where I is image classifier operator, classifying whether an operator's response is required or not for iₐ(k),
i_{b}(k) is band pass filtered object image and sᵥ is situation vector.
u(k)=g(r(k), . . . ,)=(sᵥ, c_{df}(k))^{T},
controller output/plant input, embedded messaging elements,
where g is a control operator,
sᵥ is situation vector, and
c_{df}=(l,c,f,d)^{T}εR⁴, is controlled display features where l—luminosity, c—color (RGB value), f—frequency and d—duration
p_{df}=(sᵥ,c_{df},eₛ),
operator's profile
yₘ(k+1)=f(r(k),x(k))=(tₘ(k+1),aₘ(k+1),αₘ(k+1))^{T},
reference output; desired reaction time and vehicle trajectory with respect to acquired object,
where tₘ(k+1) is reference model reaction time in msec
aₘ(k+1) is reference model acceleration in m/s²
αₘ(k+1) is reference model direction angle in degrees
yₚ(k+1)=(tₚ(k+1),aₚ(k+1),αₚ(k+1))^{T},
plant output; actual reaction time and vehicle trajectory with respect to acquired object,
where tₚ(k+1) is plant (vehicle) reaction time in msec
aₚ(k+1) is plant (vehicle) actual acceleration in m/s²
αₚ(k+1) is plant (vehicle) actual direction angle in degrees
ŷₚ(k+1)=(\hat{t}ₚ(k+1),âₚ(k+1),\hat{α}ₚ(k+1))^{T},
identifier output; emulator estimated reaction time and vehicle trajectory (resulting from NN Identifier) with respect to acquired object
where \hat{t}^{p}(k+1) is emulator estimated reaction time in msec
âₚ(k+1) is emulator estimated acceleration in m/s²
\hat{α}ₚ(k+1) is emulator estimated direction angle in degrees

$$\begin{matrix}{\hat{e}}_{c} ( k + 1 ) = {\hat{y}}_{p} ( k + 1 ) - {y}_{m} ( k + 1 ) , Control error \\ = {[ \begin{matrix}( {\hat{t}}_{p} ( k + 1 ) , {\hat{a}}_{p} ( k + 1 ) , {\hat{α}}_{p} ( k + 1 ) ) - \\ ( {t}_{m} ( k + 1 ) , {a}_{m} ( k + 1 ) , {α}_{m} ( k + 1 ) )\end{matrix} ]}^{T} \\ = {( \begin{matrix}{\hat{t}}_{p} ( k + 1 ) - {t}_{m} ( k + 1 ) , {\hat{a}}_{p} ( k + 1 ) - \\ {a}_{m} ( k + 1 ) , {\hat{α}}_{p} ( k + 1 ) - {α}_{m} ( k + 1 )\end{matrix} )}^{T}\end{matrix}$$

eᵢ(k+1)=ŷₚ(k+1)−yₚ(k+1),
Identification error; the emulator (NN) weights are adapted based on this error between the plant (vehicle) output and the neural network model (emulator) output
=[(\hat{t}ₚ(k+1),âₚ(k+1),\hat{α}ₚ(k+1))−(tₚ(k+1),aₚ(k+1),αₚ(k+1))]^{T}
=(\hat{t}ₚ(k+1)−tₚ(k+1),âₚ(k+1)−aₚ(k+1),\hat{α}ₚ(k+1)−αₚ(k+1))^{T}
eₛ(k+1)=yₚ(k+1)−yₘ(k+1),
simulator error; If eₛ(k+1) is less than the user profile threshold value (δₚₜ), then the corresponding u(k) is stored in to user profile database along with r(k).

δₚₜ, User profile threshold value, updated with the new eₛ if the eₛ is less than δₚₜ
x(k)=(vₚ(k),αₚ(k))^{T},
internal state of the plant; vehicle trajectory at time (k) with respect to acquired object,
where vₚ(k) is plant (vehicle) velocity or speed in m/s, and
αₚ(k) is the steering angle of the vehicle.

What is claimed is:

1. A method for controlling a system having embedded message elements comprising:
dynamically altering a predetermined meaning of an embedded message element as a function of a system state.

2. A method for controlling a system having embedded message elements comprising:
dynamically altering a predetermined meaning of an embedded message element as a function of a current vehicle control system state.

3. A system as controlled in claim 1.

4. A system as controlled in claim 2.

5. A method for deriving a user's preconscious sensory sensitivities profile as a function of an identification error where the identification error estimates unknown sensory sensitivities comprising:
calculating a control error between an operator response to an embedded messaging element and the predetermined meaning of the embedded messaging element.

6. A neural network identifier comprising:
an output as a function of an operator's reaction time and response to an embedded messaging element as a function of an operator's preconscious sensory sensitivity profile, the identifier anticipating the operator's response as a function of both learned sensory sensitivities and a current system state
